(19) United States
(12) Patent Application Publication
(10) Pub. No.: US 2014/0135051 A1
(43) Pub. Date: May 15, 2014

(54) METHOD, APPARATUS, AND COMPUTER PROGRAM PRODUCT FOR IMPLICIT TARGET WAKE TIME ASSIGNMENT

(71) Applicant: NOKIA CORPORATION, Espoo (FI)

(72) Inventor: Chittabrata Ghosh, Fremont, CA (US)

(73) Assignee: Nokia Corporation, Espoo (FI)

(21) Appl. No.: 13/676,422

(22) Filed: Nov. 14, 2012

(51) Int. Cl. H04W 52/02

(52) U.S. Cl. CPC H04W 52/0212
USPC 455/517

(57) ABSTRACT

Method, apparatus, and computer program product embodiments of the invention are disclosed for target wake time assignment employable, for example, in connection with wireless networks In an example embodiment of the invention, a method comprises: receiving, at a device, a message from an access node, wherein said message comprises an association identifier, and wherein said message does not comprise explicit target wake time indication; and determining, at the device, a target wake time correlating to the association identifier, wherein there is a predetermined correlation between the target wake time and the association identifier.

### FIELD

The field of the invention relates to target wake time assignment employable, for example, in connection with wireless networks.

### BACKGROUND

Modern society has adopted, and is becoming reliant upon, wireless communication devices for various purposes, such as connecting users of the wireless communication devices with other users. Wireless communication devices can vary from battery powered handheld devices to stationary household and/or commercial devices utilizing an electrical network as a power source. Due to rapid development of the wireless communication devices, a number of areas capable of enabling entirely new types of communication applications have emerged.

Cellular networks facilitate communication over large geographic areas. These network technologies have commonly been divided by generations, starting in the late 1970s to early 1980s with first generation (1G) analog cellular telephones that provided baseline voice communications, to modern digital cellular telephones. GSM is an example of a widely employed 2G digital cellular network communicating in the 900 MHZ/1.8 GHZ bands in Europe and at 850 MHz and 1.9 GHZ in the United States. While long-range communication networks, like GSM, are a well-accepted means for transmitting and receiving data, due to cost, traffic and legislative concerns, these networks may not be appropriate for all data applications.

Short-range communication technologies provide communication solutions that avoid some of the problems seen in large cellular networks. Bluetooth is an example of a short-range wireless technology quickly gaining acceptance in the marketplace. In addition to Bluetooth other popular short-range communication technologies include Bluetooth Low Energy, IEEE 802.11 wireless local area network (WLAN), Wireless USB (WUSB), Ultra Wide-band (UWB), ZigBee (IEEE 802.15.4, IEEE 802.15.4a), and ultra-high frequency radio frequency identification (UHF RFID) technologies. All of these wireless communication technologies have features and advantages that make them appropriate for various applications.

### SUMMARY

Method, apparatus, and computer program product embodiments of the invention are disclosed for target wake time assignment employable, for example, in connection with wireless networks.

In an example embodiment of the invention, a method comprises:

receiving, at a device, a message from an access node, wherein said message comprises an association identifier, and wherein said message does not comprise explicit target wake time indication; and

determining, at the device, a target wake time correlating to the association identifier, wherein there is a predetermined correlation between the target wake time and the association identifier.

In an example embodiment of the invention, the method further comprises wherein said message further comprises a duration corresponding to the association identifier.

In an example embodiment of the invention, the method further comprises wherein the target wake time determination is further based on a duration corresponding to the association identifier.

In an example embodiment of the invention, the method further comprises determining, at the device, the association identifier to be a first association identifier in a sub-block, wherein the device, by such first association identifier determination, avoids calculation.

In an example embodiment of the invention, the method further comprises performing, at the device, a calculation with respect to the association identifier.

In an example embodiment of the invention, the method further comprises wherein the calculation is performed prior to receipt of the message.

In an example embodiment of the invention, a method comprises:

accessing, at an access node device, an association identifier; and

determining, at the access node device, a target wake time correlating to the accessed association identifier, wherein there is a predetermined correlation between the target wake time and the association identifier.

In an example embodiment of the invention, the method further comprises accessing a duration corresponding to the association identifier.

In an example embodiment of the invention, the method further comprises wherein the target wake time determination is further based on an accessed duration corresponding to the association identifier.

In an example embodiment of the invention, the method further comprises determining, at the access node device, the association identifier to be a first association identifier in a sub-block, wherein the access node device, by such first association identifier determination, avoids calculation.

In an example embodiment of the invention, the method further comprises performing, at the access node device, a calculation with respect to the accessed association identifier.

In an example embodiment of the invention, the method further comprises wherein the calculation is performed prior to one or more of performing assignment with respect to the association identifier and performing notification with respect to the association identifier.

In an example embodiment of the invention, an apparatus comprises:

at least one processor; and

at least one memory including computer program code, the at least one memory and the computer program code configured to, with the at least one processor, cause the apparatus at least to perform:

receive, at the apparatus, a message from an access node, wherein said message comprises an association identifier, and wherein said message does not comprise explicit target wake time indication; and

determine, at the apparatus, a target wake time correlating to the association identifier, wherein there is a predetermined correlation between the target wake time and the association identifier.

In an example embodiment of the invention, the apparatus further comprises wherein said message further comprises a duration corresponding to the association identifier.

In an example embodiment of the invention, the apparatus further comprises wherein the at least one memory and the computer program code are further configured to, with the at least one processor, cause the apparatus to perform, at the apparatus, a calculation with respect to the association identifier.

In an example embodiment of the invention, the apparatus further comprises wherein the calculation is performed prior to receipt of the message.

In an example embodiment of the invention, an apparatus comprises:

at least one processor; and

at least one memory including computer program code, the at least one memory and the computer program code configured to, with the at least one processor, cause the apparatus at least to perform

access, at the apparatus, an association identifier; and

determine, at the apparatus, a target wake time correlating to the accessed association identifier, wherein there is a predetermined correlation between the target wake time and the association identifier.

In an example embodiment of the invention, the apparatus further comprises wherein the at least one memory and the computer program code are further configured to, with the at least one processor, cause the apparatus to access a duration corresponding to the association identifier.

In an example embodiment of the invention, the apparatus further comprises wherein the at least one memory and the computer program code are further configured to, with the at least one processor, cause the apparatus to perform, at the apparatus, a calculation with respect to the accessed association identifier.

In an example embodiment of the invention, the apparatus further comprises wherein the calculation is performed prior to one or more of performing assignment with respect to the association identifier and performing notification with respect to the association identifier.

In this manner, embodiments of the invention provide target wake time assignment functionality employable, for example, in connection with wireless networks.

### DESCRIPTION OF THE FIGURES

FIG. 1 discloses a deployment scenario for implicit target wake time (TWT) assignment functionality in accordance with at least one example embodiment of the present invention.

FIG. 2 discloses a hierarchical addressing for implicit TWT assignment functionality in accordance with at least one example embodiment of the present invention.

FIG. 3 discloses TWT hierarchical addressing correspondence in accordance with at least one example embodiment of the present invention.

FIG. 4 discloses an Association Identifier (AID)-TWT correlation calculation by a station (STA) in accordance with at least one example embodiment of the present invention.

FIG. 5 discloses an AID-TWT correlation calculation by an access point (AP) in accordance with at least one example embodiment of the present invention.

FIG. 6 discloses a further AID-TWT correlation calculation by a STA in accordance with at least one example embodiment of the present invention.

FIG. 7 discloses a further AID-TWT correlation calculation by an AP in accordance with at least one example embodiment of the present invention.

FIG. 8 discloses a computer in accordance with at least one example embodiment of the present invention.

FIG. 9A discloses a functional block diagram in accordance with at least one example embodiment of the present invention.

FIG. 9B discloses a flow diagram in accordance with at least one example embodiment of the present invention.

FIG. 9C discloses a further flow diagram in accordance with at least one example embodiment of the present invention.

FIG. 10 discloses a further computer in accordance with at least one example embodiment of the present invention.

### DISCUSSION OF EXAMPLE EMBODIMENTS OF THE INVENTION

### Implicit Target Wake Time Assignment—General Functionality

General implicit target wake time (TWT) assignment functionality according to at least one example embodiment will now be discussed. As discussed in greater detail herein, via such functionality a station (STA) (e.g., a non-traffic indication map (TIM) station) receiving (e.g., during association) an Association Identifier (AID), and in various embodiments also a discussed-herein duration, is able to determine therefrom its TWT (e.g., stated as an offset relative to a target beacon transmission time (TBTT)). The STA does not receive explicit indication of its TWT, and as such does not receive explicit indication of its TWT during association.

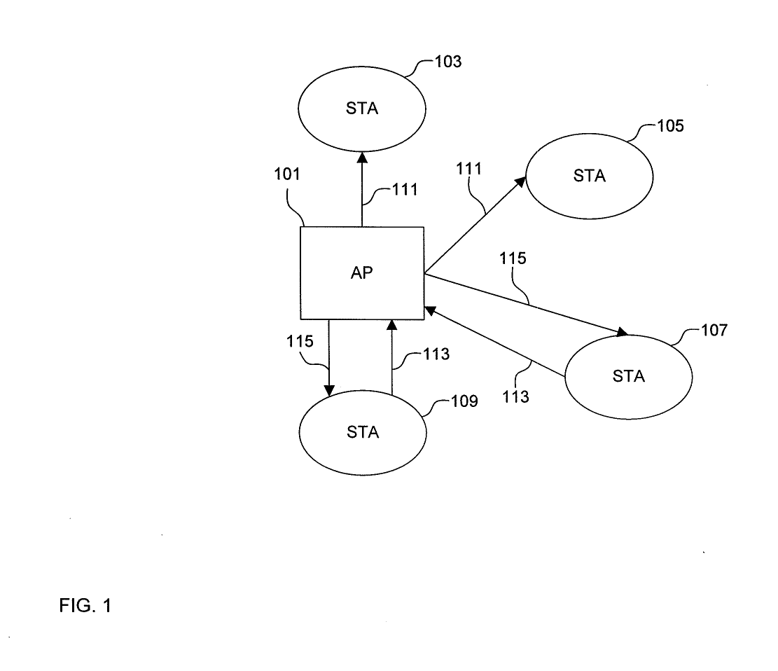

As an illustrative example of such functionality, shown in FIG. 1 is a deployment scenario, according to at least one example embodiment, for the implicit TWT assignment functionality now discussed. Shown in FIG. 1 are Institute of Electrical and Electronics Engineers (IEEE) 802.11ah-capable access point (AP) (101), TIM STAs 103 and 105, and non-TIM STAs 107 and 109.

Further according to the illustrative example, AP (101) buffers downlink data for STAs 103-109. TIM STAs 103 and 105 come to learn that such buffered downlink data awaits them by decoding beacons (111) (e.g., long and short beacons) which are dispatched by AP (101). Non-TIM STAs 107 and 109, which as a non-limiting example are power constrained, do not decode such beacons. By not decoding beacons non-TIM STAs 107 and 109 garner a number of potential benefits including power saving. As a non-limiting example, one or more of STAs 103-109 are sensors.

Still further according to the illustrative example, non-TIM STAs 107 and 109 each awaken (e.g., exit a power save mode) at its corresponding TWT and, as appropriate, perform either or both of dispatching (113) to AP (101) uplink traffic which it has buffered while asleep (e.g., while in a power save mode) and retrieving (115) downlink data from AP (101) which AP (101) has buffered while the corresponding non-TIM STA was asleep (e.g., in a power save mode). Optionally, a STA confirms the absence of traffic (e.g., via carrier sense multiple access (CSMA)) prior to uplink and/or downlink of buffered data at its TWT. In the case where a STA of non-TIM STAs 107 and 109 when awakening both dispatches to AP (101) buffered uplink data and retrieves from AP (101) buffered downlink data, such operations optionally occur in parallel. In the case of additional non-TIM STAs (e.g., non-TIM STAs beyond non-TIM STAs 107 and 109), such STAs, as a non-limiting example, analogously dispatch buffered data and/or received buffered data from AP (101) during their corresponding TWTs.

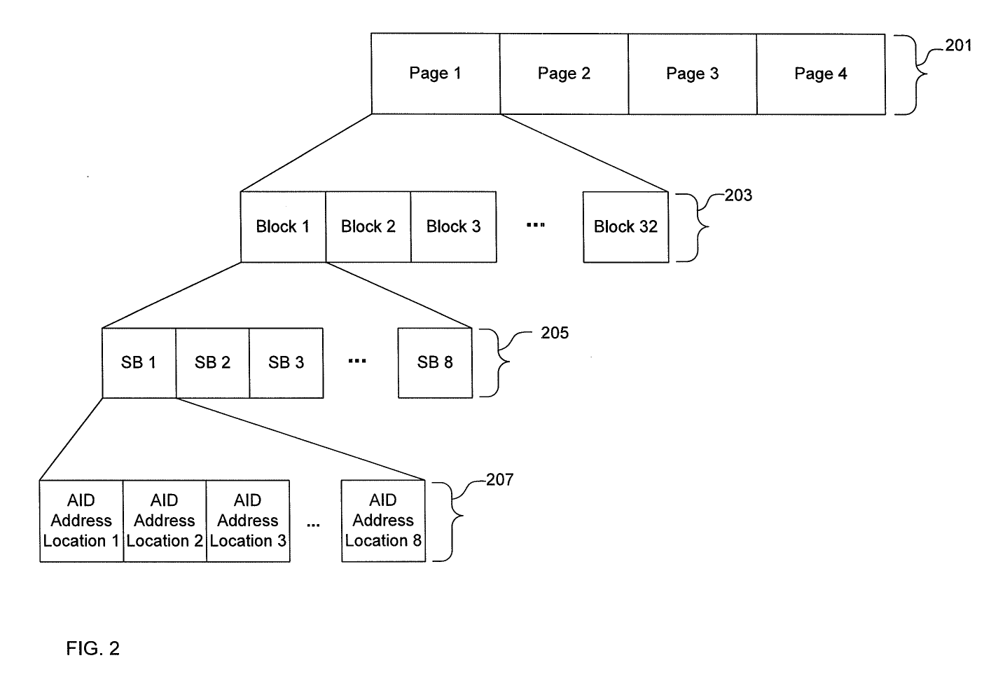

Also according to the illustrative example, a STA (e.g., a non-TIM STA) is the subject of implicit TWT assignment based on AID addressing (e.g., IEEE 802.11ah AID addressing). As a non-limiting example, the AID addressing is a hierarchical addressing. The AID addressing may comprise one or more pages. Each page may comprise one or more blocks. Each block may comprise one or more sub-blocks (SBs). Each SB may comprise one or more AID address locations, with each such AID address location corresponding to the AID of a STA (e.g., with there being AIDs ranging from 1-2007, with each of multiple STAs receiving one of the AIDs from that 1-2007 range, or with there being AIDs ranging from 1-2048 in one page, with each of multiple STAs receiving one of the AIDs from that 1-2048 range). In at least one embodiment, there can be more or less hierarchy levels in AID addressing. As a non-limiting example, with reference to FIG. 2 which shows a hierarchical addressing, according to at least one example embodiment, for the implicit TWT assignment functionality discussed herein, such hierarchy is four pages (201), 32 blocks within each page (203), eight SBs within each block (205), and eight AID address locations (207) in each SB, with each such AID address location corresponding to the AID of a STA. As is discussed in greater detail herein, such an AID, considered in view of its corresponding AID address location, correlates to a TWT.

The implementation of functionality discussed herein yields a number of potential benefits including allowing for a non-TIM STA to learn of its corresponding TWT without receiving explicit indication thereof from a corresponding AP during association, and/or providing for the saving of some or all of the AP to STA data traffic corresponding to such explicit TWT indication. As a non-limiting example, of a two octets for such data traffic, all two octets or a portion of those two octets (e.g., 1.5 octets) are saved.

### Implicit Target Wake Time Assignment—Non-Signaled Duration Functionality

Implicit target wake time assignment non-signaled duration functionality according to at least one example embodiment will now be discussed. As discussed in greater detail herein, via such functionality a STA (e.g., a non-TIM station) receiving (e.g., during association) an AID is able to determine therefrom its TWT (e.g., stated as an offset relative to a TBTT), with the duration discussed herein being set and not being signaled (e.g., not being signaled during association). The STA does not receive explicit indication of its TWT, and as such does not receive explicit indication of its TWT during association.

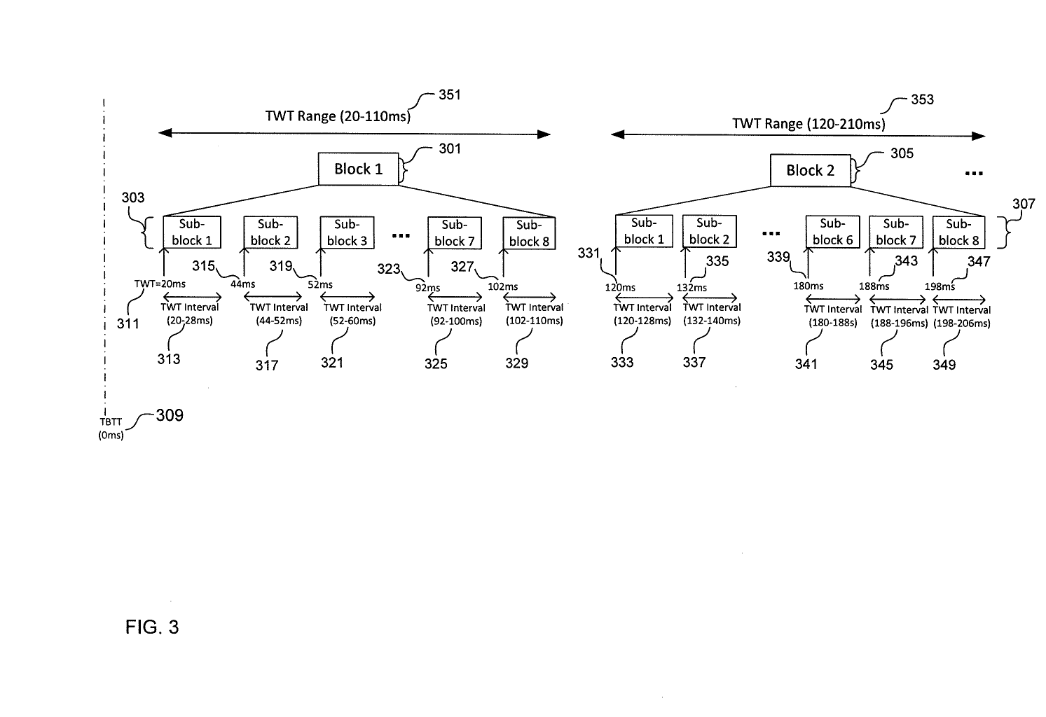

As an illustrative example of such functionality, with reference to FIG. 3, which shows TWT hierarchical addressing correspondence according to at least one example embodiment, within each block (301, 305), there are eight SBs (303, 307) and within each such SB eight AID address locations. A TWT interval is established for each SB. The TWT interval specifies a time span such that for each address location within that block there is a corresponding TWT which sits within that time span.

Further according to the illustrative example, the spacing between such TWTs is in accordance with a set duration. In connection with the non-signaled duration functionality now discussed, all such TWTs are in accordance with the same set duration (e.g., 1 ms). Optionally, a TWT range is established for each block. The TWT range for a block spans over the entire duration of the TWT intervals for the SBs of that block. The time span for each SB's interval begins at an established initial value (e.g., stated in ms and/or as an offset relative to a TBTT) and ends at an end value which flows from that initial value, the number of AID address locations per corresponding SB, and the set duration. The value (e.g., in ms) for such a time span flows from the number of AID address locations per corresponding SB and the set duration. As an example, such span is 8 ms in the case of eight AID address locations per corresponding SB and a set duration of 1 ms. As noted, the TWT range for a block spans over the entire duration of the TWT intervals for the SBs of that block.

Still further according to the illustrative example, the first time value in a given TWT range for a block is the initial value of the TWT interval of the first SB of that block, and the final time value in that TWT range is the end value of the TWT interval of the last SB of that block. The value (e.g., in ms) of the time span for each block's range flows from the number of SBs in that block, the number of AID address locations per each such SB, and the set duration. As an illustrative example, such block time span is 64 ms in the case of eight SBs in the block, eight AID address locations per each SB, and a set duration of 1 ms.

Also according to the illustrative example, with further reference to FIG. 3 an example of a set duration of 1 ms is depicted. Within block 1 (301) are its eight SBs, SB 1 through SB 8 (303). SB1 of block 1 (301) has an initial value of 20 ms (311) and a TWT interval (313) which spans from 20-28 ms. SB 2 of block 1 (301) has an initial value (315) of 44 ms and a TWT interval (317) which spans from 44-52 ms. SB 3 of block 1 (301) has an initial value (319) of 52 ms and a TWT interval (321) which spans from 52-60 ms. SB 7 of block 1 (301) has an initial value (323) of 92 ms and a TWT interval (325) which spans from 92-100 ms. SB 8 of block 1 (301) has an initial value (327) of 102 ms and a TWT interval (329) which spans from 102-110 ms. TWT range (351) for block 1 (301) spans from 20-110 ms. In the foregoing, the values are stated as an offset relative to TBTT (309).

Additionally according to the illustrative example, with still further reference to FIG. 3 within block 2 (305) are its eight SBs, SB 1 through SB 8 (307). SB1 of block 2 (305) has an initial value of 120 ms (331) and a TWT interval (333) which spans from 120-128 ms. SB 2 of block 2 (305) has an initial value (335) of 132 ms and a TWT interval (337) which spans from 132-140 ms. SB 6 of block 2 (305) has an initial value (339) of 180 ms and a TWT interval (341) which spans from 180-188 ms. SB 7 of block 2 (305) has an initial value (343) of 188 ms and a TWT interval (345) which spans from 188-196 ms. SB 8 of block 2 (305) has an initial value (347) of 198 ms and a TWT interval (349) which spans from 198-206 ms. TWT range (353) for block 2 (305) spans from 120-210 ms. In the foregoing, the values are stated as an offset relative to TBTT (309).

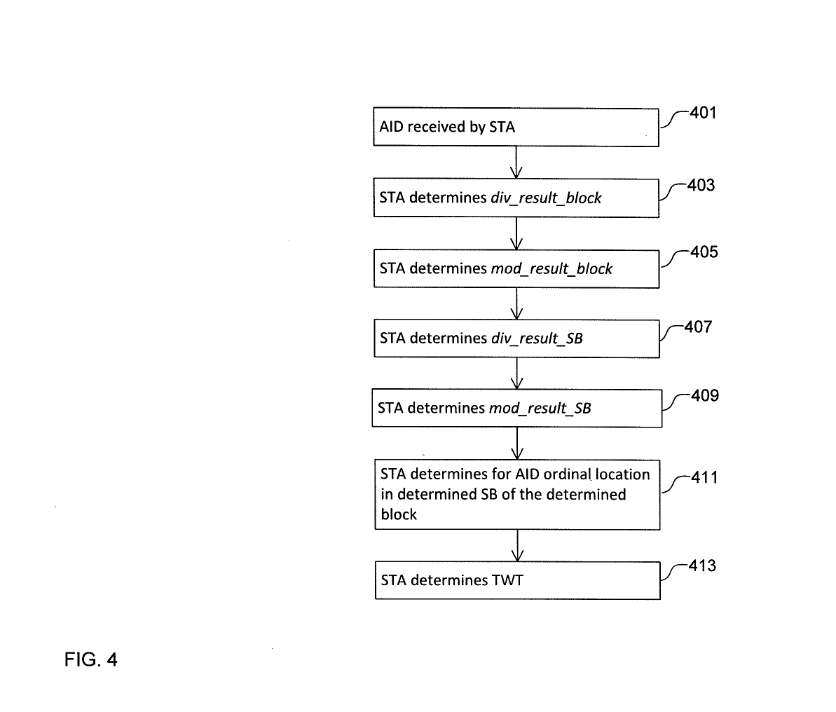

Further according to the illustrative example, with reference to FIG. 4, which shown an AID-TWT correlation calculation by a STA according to at least one example embodiment, a STA (e.g., a non-TIM STA) learns from an AP during association an AID (e.g., an AID of 78, perhaps taken from the range 1-2007 or from the range 1-2048) (401). The STA (e.g., by virtue of knowing the corresponding AID addressing hierarchy) is aware of the number of AID address locations per corresponding block (e.g., 64 AID address locations). The STA then performs a DIV operation upon that AID and that number of AID address locations:

div_result_block=STA_AID DIV number_of_AID_per_block (403).

For a STA_AID of 78 and a number_of_AID_per_block of 64, such operation yields a result of 1.

Additionally according to the illustrative example, the STA performs a MOD operation upon that AID and that number of AID address locations:

mod_result_block=STA_AID MOD number_of_AID_per_block (405).

For a STA_AID of 78 and a number_of_AID_per_block of 64, such operation yields a mod_result_block result of 14.

The STA (e.g., by virtue of knowing the corresponding AID addressing hierarchy) is aware of the number of AID address locations per SB (e.g., 8). The STA then performs a DIV operation upon mod_result_block and that number of AID address locations per SB:

div_result_SB=mod_result_block DIV number_of_AID_per_SB (407).

For a mod_result_block of 14 and a number_of_AID_per_SB of 8, such operation yields a result of 1. The STA then performs a MOD operation upon mod_result_block and number of AID_per_SB:

mod_result_SB=mod_result_block MOD number_of_AID_per_SB (409).

For a mod_result_block of 14 and a number_of_AID_per_SB of 8, such operation yields a result of 6. From this the STA knows that its AID is the mod_result_SB-th AID in SB (div_result_SB+1) of block (div_result_block+1) (411).

For a mod_result_SB of 6, a div_result_SB of 1, and a div_result_block of 1, the STA finds itself to have the 6th AID in SB 2 of block 2.

Still further according to the illustrative example, the STA determines its TWT (e.g., as an offset relative to a TBTT) as:

TWT=corresponding_initial_value+((mod_result_SB−1)*set_duration)(413).

Further according to the illustrative example, the STA optionally after performing 411 checks whether or not its AID is the first AID in the determined SB. Where the STA finds its AID to be the first AID in the determined SB, it considers its TWT to be corresponding_initial_value and does not perform 413. Where the STA finds its AID to not be the first AID in the determined SB it proceeds to perform 413.

Still further according to the illustrative example, the STA optionally performs AID-TWT correlation precalculation. Accordingly, rather than receiving a particular AID (e.g., during association) and then performing the above-discussed calculations with respect to that particular received AID, the STA precalculates for each of one or more AID values taken from a pool of possible AID values the corresponding TWT. As such, the STA, with receipt of an AID, is able to retrieve the corresponding precalculated TWT.

As to corresponding_initial_value and set_duration, the STA is aware of the set duration and is aware of the initial value for the above-determined SB of the above-determined block. For the initial values discussed in connection with FIG. 3, such determined SB being 2 and such determined block being 2, the corresponding_initial_value is 132 ms. Further, for FIG. 3 the set duration is 1 ms. As such, for such a corresponding_initial_value of 132 ms, a mod_result_SB of 6, and a set duration of 1 ms, so calculating TWT yields a result of 137 ms.

Additionally according to the illustrative example, with additional reference to FIG. 3, SB 1 of block 1 (301) has a TWT interval (313) whose span ends at 28 ms while SB 2 of block 1 (301) has a TWT interval (317) whose span starts at 44 ms, thus yielding a gap from 28 ms to 44 ms. In contrast, SB 2 of block 1 (301) has a TWT interval (317) whose span ends at 52 ms while SB 3 of block 1 (301) has a TWT interval (321) whose span starts at 52 ms, thus not yielding such a gap. As a non-limiting example, such gaps reflect only one or more portions of the beacon period which commences with beacon period start (309) being used for non-TIM STAs, the balance of the beacon period being not used, or being used for other than non-TIM STAs. Examples of such non-TIM STA use include use for TIM STAs having AIDs pulled from a different AID pool space (e.g., pulled from a different particular pool space of AIDs ranging from 1-2007 or from 1-2048) than the non-TIM STAs whose AIDs indicate TWTs as discussed herein, and/or use for restricted access windows (RAWs).

Also according to the illustrative example, as a further non-limiting example, where non-TIM STAs whose AIDs indicate TWTs as discussed herein and TIM STAs have AIDs pulled from the same AID pool space, certain pages, blocks, and/or corresponding AID address hierarchy are designated for such non-TIM STAs and other pages, blocks, and/or SBs of that AID address hierarchy are designed for such TIM STAs. As such some AIDs from the corresponding pool (e.g., a pool of AIDs ranging from 1-2007 or from 1-2048) are given to such non-TIM STAs and other AIDs from that pool are given to such TIM STAs. AID-TWT correlation reflects this. As a particular example, a nth SB (e.g., a SB 1) has a TWT interval which ends at x ms (e.g., 16 ms) and a (n+2)th SB (e.g., a SB 3) has a TWT interval which starts at that same x ms (e.g., 16 ms) reflecting the nth SB (e.g., SB 1) and the (n+2)th SB (e.g., SB 3) being for non-TIM STAs and the (n+1)th SB (e.g., SB 2) being for TIM STAs.

Further according to the illustrative example, it is noted that the discussed calculations by which a STA determines the TWT which correlates to its AID are compatible with circumstances wherein AID-TWT correlation is not a linear one within an element (e.g., within a page or block). The presence of such linearity is evidenced by the TWT for a given AID being determinable by solving an equation in the form of TWT=AID+X, where X a commencement value (e.g., where X represents that start of an appropriate TWT range). Such lack of linear correlation arises in situations including those discussed above concerning TIM STAs and non-TIM STAs having AIDs pulled from the same AID pool space, and TIM and non-TIM STAs having AIDs pulled from different AID pool spaces.

Still further according to the illustrative example, it is noted that the AID-TWT calculation discussed above calculated, for an AID of 48, a corresponding TWT (e.g., with TWT being expressed as an offset relative to a TBTT) of 137 ms, a value which correctly takes into account the discussed gaps depicted in FIG. 3. In contrast, an attempt at a pure linear calculation of the TWT (e.g., with TWT being expressed as an offset relative to a TBTT) corresponding to the AID of 78 would prove incompatible with the discussed gaps depicted in FIG. 3. To wit, such a pure linear calculation would involve calculating TWT (e.g., with TWT being expressed as an offset relative to a TBTT) as:

TWT=start_of_range_for_first_block+((AID−1)*set_duration)

With an eye towards FIG. 3, start_of_range_for_first_block is 20 ms, set duration is 1 ms, and as referenced AID is 78, thus yielding a result of TWT=97 ms rather than the correct value of 137 ms which results from calculation appropriately compatible with the discussed gaps of FIG. 3.

Additionally according to the illustrative example, as discussed a STA performs calculations in order to determine the TWT (e.g., expressed as an offset relative to a TBTT) which correlates with its received AID. The STA awakens at its TWT to dispatch buffered data to and/or receive buffered data from its AP. The AP is likewise capable of determining, for each of one or more of its STAs, the TWT (e.g., expressed as an offset relative to a TBTT) that correlates with the AID of that STA. Such determination by the AP yields a number of potential benefits including being able to know when to expect exchange of buffered data with a given STA. As a non-limiting example, the AP is not aware of the TWT of such a STA prior to such determination.

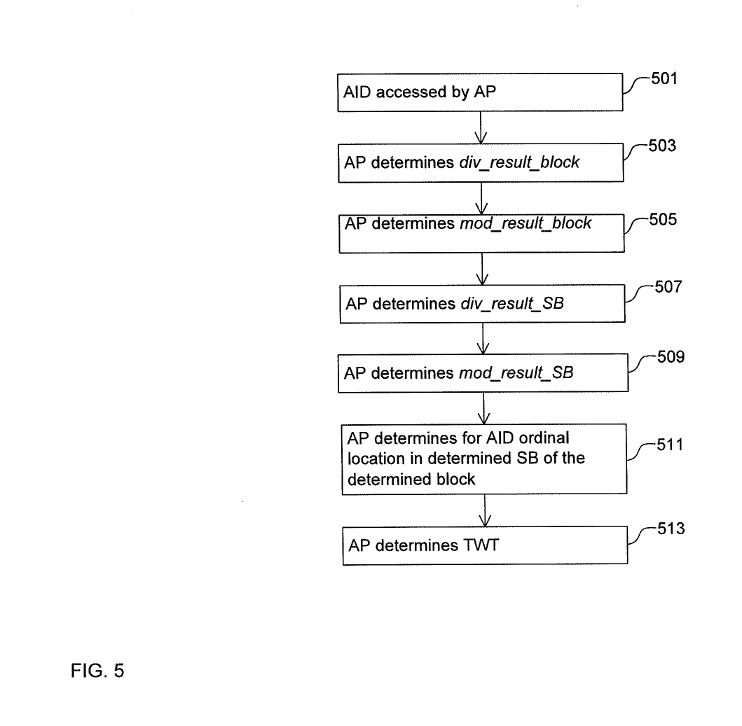

Also according to the illustrative example, such an AP calculates such AID-TWT correlation in a manner analogous to the non-signaled duration AID-TWT correlation calculations discussed above as being performed by a STA. As such, with reference to FIG. 5 which shows a AID-TWT correlation calculation by an AP according to at least one example embodiment, the AP accesses (e.g., from a storage location) the AID corresponding to the STA with respect to which TWT is to be determined (501). Next, the AP determines div_result_block (503) in a manner analogous to that discussed above in connection with FIG. 4, determines mod_result_block (505) in a manner analogous to that discussed above in connection with FIG. 4, determines div_result_SB (507) in a manner analogous to that discussed above in connection with FIG. 4, determines mod_result_SB (509) in a manner analogous to that discussed above in connection with FIG. 4, determines for the appropriate AID the ordinal location in the determined SB of the determined block (511) in a manner analogous to that discussed above in connection with FIG. 4, and determines the TWT (513) in a manner analogous to that discussed above in connection with FIG. 4.

Also according to the illustrative example, optionally after performing 511 the AP acts in a manner analogous to that discussed above in connection with FIG. 4 with regard to checking whether or not an AID is the first AID in a determined SB.

Additionally according to the illustrative example, the AP optionally performs AID-TWT correlation precalculation in a manner analogous to that discussed above. As such, the AP, assigning an AID to a particular STA and/or informing a particular STA of its AID, is able to retrieve the corresponding precalculated TWT.

Further according to the illustrative example, a STA, from an AP during association, learns of its AID. The STA is additionally aware of information including the number of AID address locations per block, the number of AID address locations per SB, the AID addressing hierarchy, the initial values of intervals, and/or of the set duration at hand. Examples of modes of awareness of such information include one or more of receipt from a corresponding AP and/or server (e.g., at association and/or at one or more times other than association), incorporation into STA program code and/or data stores (e.g., wherein the STA is provided with such information during manufacture, software install, and/or software upgrade), entry by an individual (e.g., by a STA user and/or by a system administrator), and awareness due to other information (e.g., awareness due to knowledge of a corresponding AID addressing hierarchy).

Still further according to the illustrative example, aspects including one or more of the assignment of AIDs to STAs, the number of AID address locations per block, the number of AID address locations per SB, the AID addressing hierarchy, the initial values of intervals, and the set duration are defined in a number of ways including definition by an individual (e.g., by an AP user and/or by a system administrator), definition (e.g., performed at a time prior to a corresponding AID-TWT correlation calculation discussed herein) by a manufacturer, and/or automated definition (e.g., with an AP defining one or more of such values to meet resource scheduling, power saving, and/or other goals). As the AID-TWT correlation calculations discussed herein take into account various of these aspects, such aspect definition serves to define AID-TWT correlation. As a non-limiting example, by defining one or more of AID to STA assignment, the initial values of intervals, and set duration, such an individual, manufacturer, and/or automated definition acts to define AID-TWT correlation.

Also according to the illustrative example, it is noted that a STA (e.g., an 802.11ah non-TIM STA) conventionally learns explicitly of its TWT during association with an AP (e.g., an 802.11ah AP) via a dispatch of data (e.g., data being two octets in length), from the AP to the STA, which specifies that TWT. In connection with the above-discussed implicit target wake time assignment non-signaled duration functionality, the STA does not receive such explicit TWT indication and instead determines the TWT using the above-discussed received AID. As such, and taking into account that such above-discussed implicit target wake time assignment non-signaled duration functionality does not call for the above-discussed duration to be signaled to the STA, the entirety of the data corresponding to conventional TWT dispatch (e.g., the entire two octets) is saved, thus yielding potential benefits including power saving.

### Implicit Target Wake Time Assignment—Signaled Duration Functionality

Implicit target wake time assignment signaled duration functionality according to at least one example embodiment will now be discussed. As discussed in greater detail herein, via such functionality a STA (e.g., a non-TIM station) receiving (e.g., during association) an AID and a discussed-herein duration is able to determine therefrom its TWT (e.g., stated as an offset relative to a TBTT). The STA does not receive explicit indication of its TWT, and as such does not receive explicit indication of its TWT during association.

As an illustrative example of such functionality, an alteration of the above-discussed implicit target wake time assignment non-signaled duration functionality allows for STA determination of TWT in the absence of explicit TWT indication under the circumstance where duration varies on, for instance, a per-SB basis. As a non-limiting example, suppose the duration for a first SB being 1 ms and the duration for a second SB being 2 ms, thus being in contrast to the example described in connection with non-signaled functionality wherein the same 1 ms duration applied to all SBs.

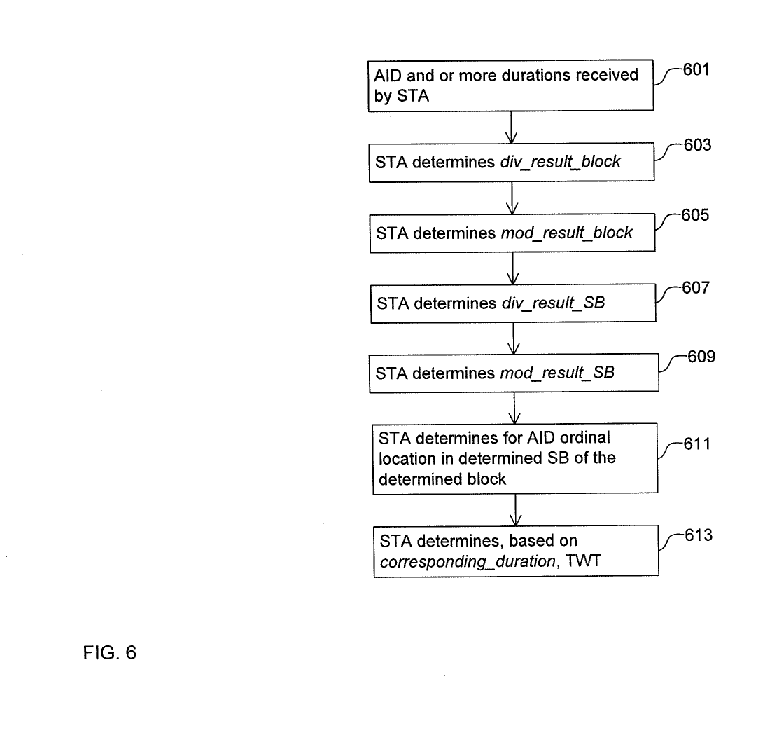

Further according to the illustrative example, with reference to FIG. 6 which shows a further AID-TWT correlation calculation by a STA according to at least one example embodiment, the STA acts in a manner generally analogous to that discussed in connection with 401, but learning from an AP during association not just an AID but also one or more durations for one or more SBs (601). Optionally, the STA only receives the duration for the SB within which its AID is situated. The STA then determines div_result_block (603) in a manner analogous to that discussed above in connection with 403, determines mod_result_block (605) in a manner analogous to that discussed above in connection with 405, determines div_result_SB (607) in a manner analogous to that discussed above in connection with 407, determines mod_result_SB (609) in a manner analogous to that discussed above in connection with 409, and determines for the appropriate AID the ordinal location in the determined SB of the determined block (611) in a manner analogous to the discussed above in connection with 411.

Still further according to the illustrative example, the STA then determines the TWT in a manner generally analogous to that discussed above in connection with 413, but employing in place of set_duration of 413 corresponding_duration, where corresponding_duration is the duration for the 609-determined SB of the 609-determined block (613). As such the STA calculates its TWT (e.g., as an offset relative to a TBTT) as:

TWT=corresponding_initial_value+((mod_result_SB−1)*corresponding_duration).

Additionally according to the illustrative example, returning to the example of FIG. 4 but now employing corresponding_duration and taking the value thereof to be 3 ms for the determined SB of the determined block, taking mod_result_SB to be 6 in connection with the corresponding performance of 609, and taking corresponding_initial_value to remain as 132 ms, and as such not to have been affected by duration differences, yields a result of 147 ms.

Also according to the illustrative example, optionally after performing 611 the STA acts in a manner analogous to that discussed above in connection with FIG. 4 with regard to checking whether or not an AID is the first AID in a determined SB.

Further according to the illustrative example, the STA optionally performs AID-TWT precalculation in a manner analogous to that discussed above. As a non-limiting example, the STA is aware of the duration which would apply to a given AID and employs that duration value in precalculation. As another non-limiting example, the STA performs such precalculation for a given AID with respect to a plurality of possible durations for that AID.

Also according to the illustrative example, as discussed a STA is capable of performing calculations in order to determine the TWT (e.g., expressed as an offset relative to a TBTT) which correlates with its received AID and further taking into account a received duration. The AP is likewise capable of determining, for one or more of its STAs, the TWT the correlates with the AID for that STA and with the appropriate corresponding duration.

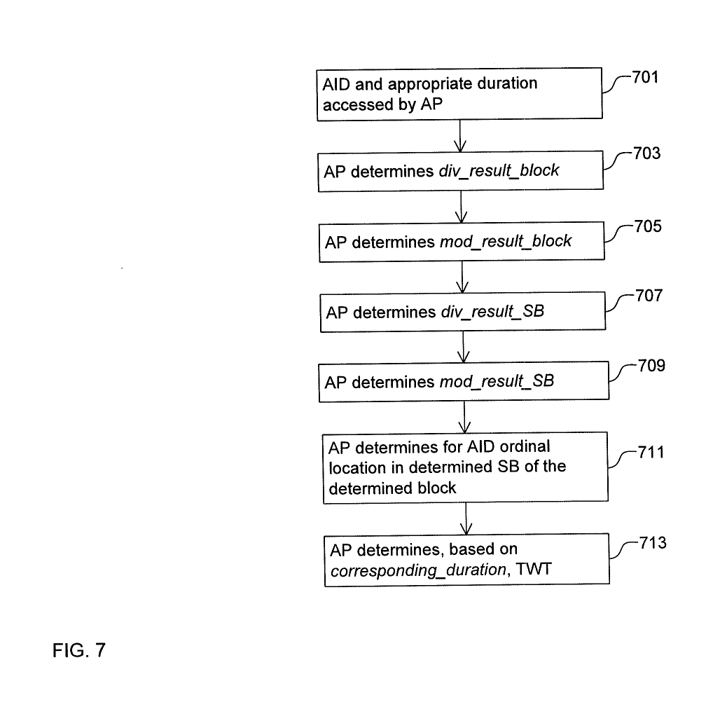

Further according to the illustrative example, such AP calculates such AID-TWT correlation in a manner analogous to the signaled duration AID-TWT correlation calculations discussed herein as being performed by a STA. As such, with respect to FIG. 7 which shows a further AID-TWT correlation calculation by an AP according to at least one example embodiment, for each of one or more of its STAs the AP accesses (e.g., from a storage location) the AID and appropriate duration corresponding to the STA with respect to which TWT is to be determined (701). Next, the AP determines div_result_block (703) in a manner analogous to that discussed above in connection with FIG. 6, determines mod_result_block (705) in a manner analogous to that discussed above in connection with FIG. 6, determines div_result_SB (707) in a manner analogous to that discussed above in connection with FIG. 6, determines mod_result_SB (709) in a manner analogous to that discussed above in connection with FIG. 6, determines for the AID the ordinal location in the determined SB of the determined block (711) in a manner analogous to that discussed above in connection with FIG. 6, and determines, based on corresponding_duration, the TWT (713) in a manner analogous to that discussed above in connection with FIG. 6. The AP optionally acts in a manner analogous to that discussed above with regard to checking whether or not an AID is the first AID in a determined SB. The AP optionally performs AID-TWT precalculation in a manner analogous to that discussed above. As a non-limiting example, the AP is aware of the duration which would apply to a given AID and employs that duration in precalculation. As another non-limiting example, the AP performs such precalculation for a given AID with respect to a plurality of possible durations for that AID.

Also according to the illustrative example, it is noted that a STA (e.g., an 802.11ah non-TIM STA) conventionally learns explicitly of its TWT during association with an AP (e.g., an 802.11ah AP) via a dispatch of data (e.g., data being two octets in length), from the AP to the STA, which specifies that T. In connection with the above-discussed implicit target wake time assignment signaled duration functionality, the STA does not receive such explicit TWT indication and instead determines the TWT using the above-discussed received AID and the above-discussed received duration. As such, and taking into account that such above-discussed implicit target wake time assignment signaled duration functionality calls for the duration to be signaled to the STA (e.g., requiring half an octet), a portion of the data corresponding to conventional TWT dispatch (e.g., a portion of the two octets) is saved, thus yielding potential benefits including power saving. As a non-limiting example, in the case where conventional TWT dispatch requires two octets and duration signaling requires half an octet, 1.5 octets are saved relative to conventional functionality.

### Hardware and Software

The foregoing discusses computers, such as the discussed AP and STA devices, performing a number of operations. Examples of computers include smart cards, media devices, personal computers, engineering workstations, PCs, Macintoshes, PDAs, portable computers, computerized watches, wired and wireless terminals, telephones, communication devices, nodes, servers, network access points, network multicast points, network devices, network stations, set-top boxes, personal video recorders (PVRs), game consoles, portable game devices, portable audio devices, portable media devices, portable video devices, televisions, digital cameras, digital camcorders, Global Positioning System (GPS) receivers, sensors, and wireless personal servers.

Running on such computers are often one or more operating systems. Examples of operating systems include Windows Phone (e.g., Windows Phone 8 or Windows Phone 7), Windows (e.g., Windows 8, Windows 7, or Windows Vista), Windows Server (e.g., Windows Server 2012, Windows server 2008, or Windows Server 2003), Maemo, Symbian OS, WebOS, Linux, OS X, and iOS. Supported by such computers are optionally one or more of the S60 Platform, the .NET Framework, Java, and Cocoa.

Examples of computers also include one or more processors operatively connected to one or more memory or storage units, wherein the memory or storage optionally contains data, algorithms, and/or program code, and the processor or processors execute the program code and/or manipulate the program code, data, and/or algorithms.

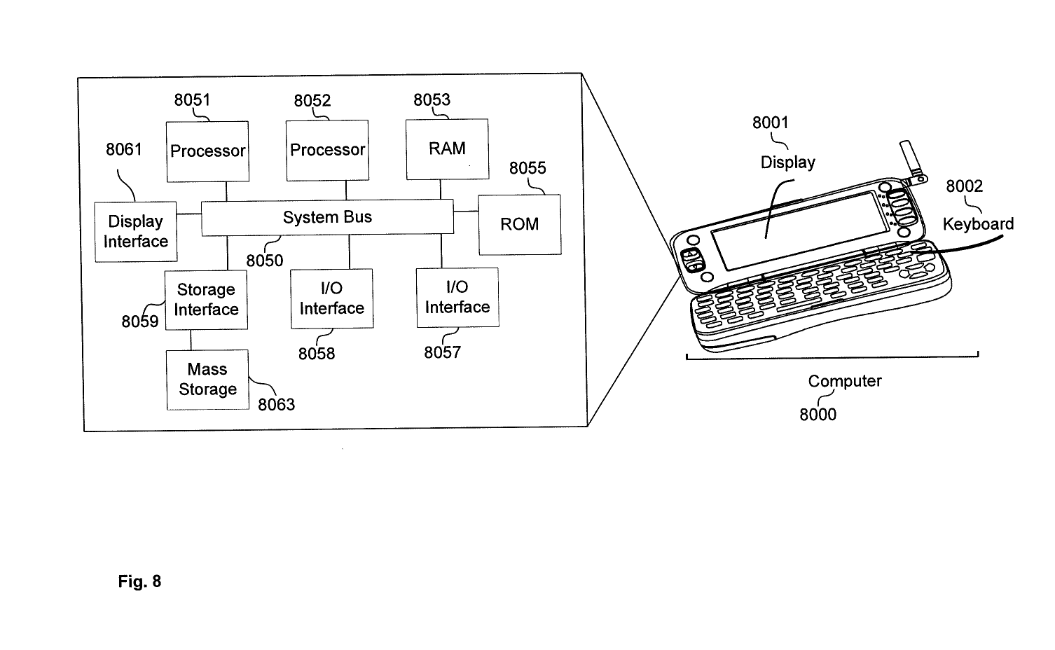

FIG. 8 shows example computer 8000 including system bus 8050 which operatively connects two processors 8051 and 8052, random access memory 8053, read-only memory 8055, input output (I/O) interfaces 8057 and 8058, storage interface 8059, and display interface 8061. Storage interface 8059 in turn connects to mass storage 8063. Each of I/O interfaces 8057 and 8058 is an Ethernet, IEEE 1394, IEEE 1394b, IEEE 802.11a, 802.11af, 802.11ah, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16m, IEEE 802.16x, IEEE 802.20, IEEE 802.22, IEEE 802.15.3, ZigBee (e.g., IEEE 802.15.4), Bluetooth (e.g., IEEE 802.15.1), Ultra Wide Band (UWB), Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Multimedia Broadcast-Terrestrial (DMB-T), MediaFLO (Forward Link Only), Terrestrial Digital Multimedia Broadcasting (T-DMB), Digital Audio Broadcast (DAB), Digital Radio Mondiale (DRM), General Packet Radio Service (GPRS), Universal Mobile Telecommunications Service (UMTS), Long Term Evolution (LTE), Global System for Mobile Communications (GSM), Code Division Multiple Access 2000 (CDMA2000), DVB-H (Digital Video Broadcasting: Handhelds), HDMI (High-Definition Multimedia Interface), Thunderbolt, or IrDA (Infrared Data Association) interface.

Further according to FIG. 8 mass storage 8063 is a hard drive or flash memory. Each of processors 8051 and 8052 is an ARM-based processor such as a Qualcomm Snapdragon or an x86-based processor such as an Intel Atom or Intel Core. Computer 8000 as shown in this example also includes a touch screen 8001 and physical keyboard 8002. Optionally a mouse or keypad is alternately or additionally employed. Moreover, one or more of touch screen 8001 and physical keyboard 8002 are optionally eliminated.

Additionally according to FIG. 8 computer 8000 optionally includes or is attached to one or more image capture devices. Examples of image capture devices include ones employing Complementary Metal Oxide Semiconductor (CMOS) hardware and ones employing Charge Coupled Device (CCD) hardware. One or more of the image capture devices are according to one example of an implementation aimed towards the user. Alternately or additionally, one or more of the image capture devices are aimed away from the user. The one or more image capture devices are optionally employed by computer 8000 for video conferencing, still image capture, and/or video capture. Moreover, computer 8000 optionally includes or is attached to one or more card readers, DVD drives, floppy disk drives, hard drives, memory cards, or ROM devices whereby media containing program code—such as program code for performing the discussed operations—is optionally inserted for the purpose of loading the code onto the computer. Further, program code—such as program code for performing the discussed operations—is optionally loaded the code onto the computer via one or more of I/O interfaces 8057 and 8058, perhaps using one or more networks.

According to an example of an implementation, executed by computers discussed herein are one or more software modules designed to perform one or more of the discussed operations. Such modules are programmed using one or more languages. Examples of languages include C#, C, C++, Objective C, Java, Perl, and Python. Corresponding program code is optionally placed on media. Examples of media include DVD, CD-ROM, memory card, and floppy disk.

Any indicated division of operations among particular software modules is for purposes of illustration, and alternate divisions of operation are possible. Accordingly, any operations indicated to be performed by one software module are according to an alternative implementation instead performed by a plurality of software modules. Similarly, any operations indicated to be performed by a plurality of modules are according to an alternative implementation instead be performed by a single module.

Further, any operations indicated to be performed by a particular computer such as a particular device are according to an alternative implementation instead performed by a plurality of computers such as by a plurality of devices. Moreover, peer-to-peer, cloud, and/or grid computing techniques are optionally employed. Additionally, implementations include remote communication among software modules. Examples of remote communication techniques include Simple Object Access Protocol (SOAP), Java Messaging Service (JMS), Remote Method Invocation (RMI), Remote Procedure Call (RPC), sockets, and pipes.

Optionally, operations discussed herein are implemented via hardware. Examples of such implementation via hardware include the use of one or more of integrated circuits, specialized hardware, chips, chipsets, Application-Specific Integrated Circuits (ASICs), and Field-Programmable Gate Arrays (FPGAs). As a non-limiting example such hardware is programed to perform operations discussed herein using one or more languages such as one or more Hardware Description Languages (HDLs). Examples of HDLs include very-high-speed integrated circuit hardware description language (VDHL) and Verilog.

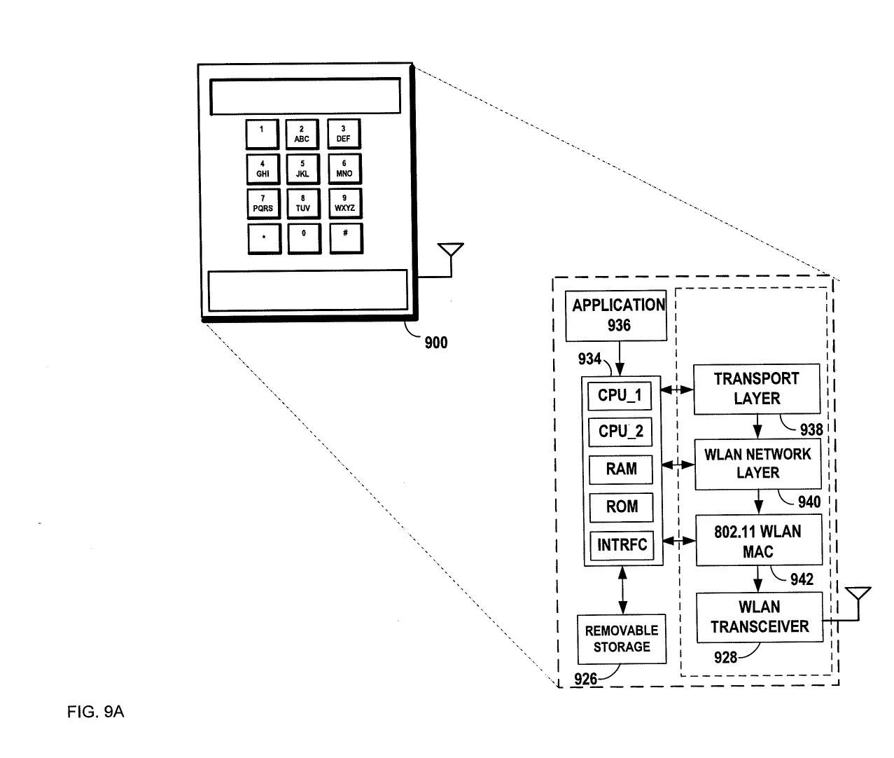

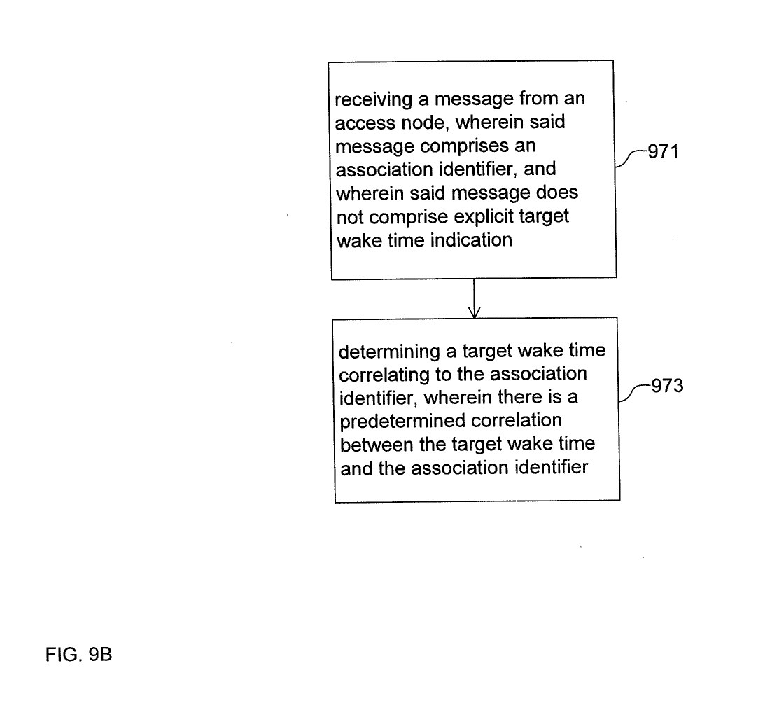

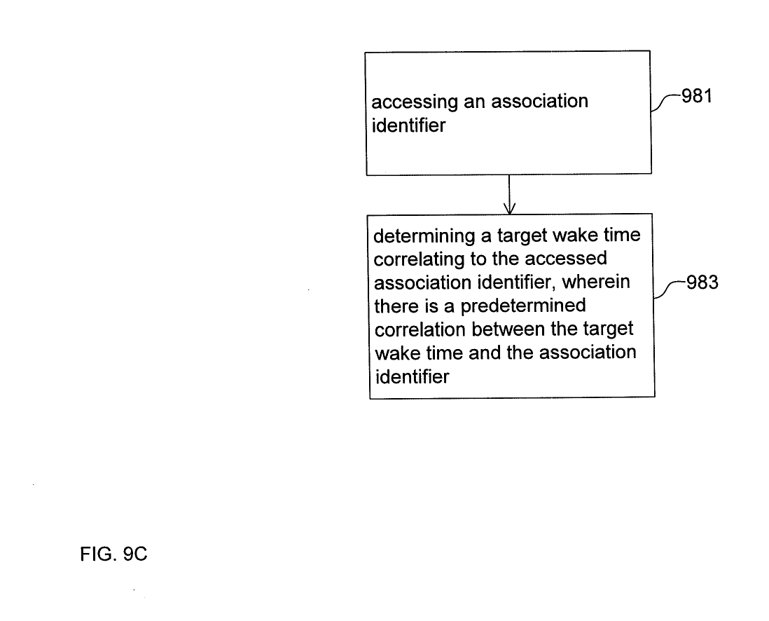

FIG. 9A is an example functional block diagram, illustrating an example AP or STA device 900 according to an example embodiment of the invention. The example device 900 includes a processor 934 that includes dual or multi-core central processing units CPU_{—}1 and CPU_{—}2, a RAM memory, a ROM memory, and an interface for a keypad, display, and other input/output devices. The example device 900 includes a protocol stack, including the transceiver 928 and IEEE 802.11ah MAC 942. The protocol stack includes a network layer 940, a transport layer 938, and an application program 936.

In an example embodiment, the interface circuits in FIG. 9A interface with one or more radio transceivers, battery and other power sources, key pad, touch screen, display, microphone, speakers, ear pieces, camera or other imaging devices, etc. The RAM and ROM are optionally removable memory devices 926 such as smart cards, subscriber identity modules (SIMs), wireless identification modules (WIMs), semiconductor memories such as RAM, ROM, PROMS, flash memory devices, etc. The processor protocol stack layers, and/or application program are according to an example of an implementation embodied as program logic stored in the RAM and/or ROM in the form of sequences of programmed instructions which, when executed in the CPU, carry out the functions of example embodiments. The program logic is according to an example of an implementation delivered to the writeable RAM, PROMS, flash memory devices, etc. from a computer program product or article of manufacture in the form of computer-usable media such as resident memory devices, smart cards or other removable memory devices. Alternately, they are embodied as integrated circuit logic in the form of programmed logic arrays or custom designed ASICs. The one or more radios in the device are separate transceiver circuits or alternately, the one or more radios are a single RF module capable of handling one or multiple channels in a high speed, time and frequency multiplexed manner in response to the processor. Examples of removable storage media 926 include those based on magnetic, electronic, and/or optical technologies, such as magnetic disks, optical disks, semiconductor memory circuit devices, and micro-SD memory cards (SD refers to the Secure Digital standard) for storing data and/or computer program code as an example computer program product, in accordance with at least one embodiment of the present invention.

In an example embodiment of the invention, the device 900 of FIG. 9A is a device, comprising:

at least one processor 934;

at least one memory, RAM, ROM, and/or removable storage 926 including computer program code represented by the flow diagram of FIG. 9B;

the at least one memory and the computer program code configured to, with the at least one processor, cause the device 900 at least to:

receive a message from an access node, wherein said message comprises an association identifier, and wherein said message does not comprise explicit target wake time indication; and

determine a target wake time correlating to the association identifier, wherein there is a predetermined correlation between the target wake time and the association identifier.

FIG. 9B discloses a flow diagram in accordance with at least one example embodiment of the present invention. 971 and 973 of FIG. 9B as a non-limiting example represent computer code instructions stored in the RAM and/or ROM memory of device 900, which when executed by the central processing units (CPU), carry out the functions of an example embodiment of the invention. 971 and 973 are performable in another order than shown and are combinable and/or separable into component operations. As such:

971: receiving a message from an access node, wherein said message comprises an association identifier, and wherein said message does not comprise explicit target wake time indication; and

973: determining target wake time correlating to the association identifier, wherein there is a predetermined correlation between the target wake time and the association identifier.

In a further example embodiment of the invention, the device 900 of FIG. 9A is a device, comprising:

at least one processor 934;

at least one memory, RAM, ROM, and/or removable storage 926 including computer program code represented by the flow diagram of FIG. 9C;

the at least one memory and the computer program code configured to, with the at least one processor, cause the device 900 at least to:

access an association identifier; and

determine a target wake time correlating to the accessed association identifier, wherein there is a predetermined correlation between the target wake time and the association identifier.

FIG. 9C discloses a further flow diagram in accordance with at least one example embodiment of the present invention. 981 and 983 of FIG. 9C as a non-limiting example represent computer code instructions stored in the RAM and/or ROM memory of device 900, which when executed by the central processing units (CPU), carry out the functions of an example embodiment of the invention. 981 and 983 are performable in another order than shown and are combinable and/or separable into component operations. As such:

981: accessing an association identifier; and

983: determining a target wake time correlating to the accessed association identifier, wherein there is a predetermined correlation between the target wake time and the association identifier.

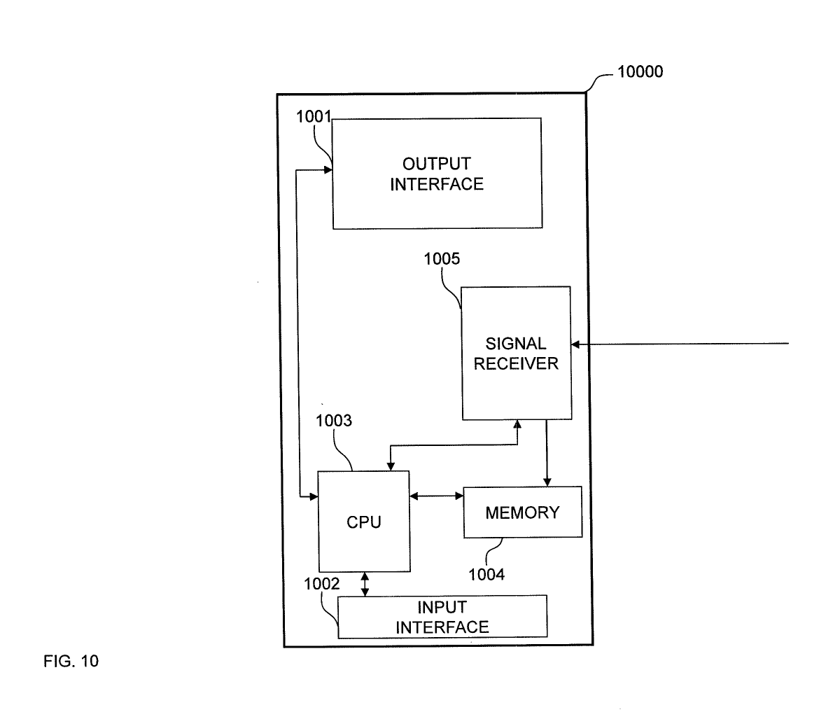

As noted, the foregoing discusses computers such as the discussed AP and STA devices. Shown in FIG. 10 is a block diagram of a further computer according to at least one example embodiment, terminal 10000. Terminal 10000 of FIG. 10 includes a processing unit CPU 1003, a signal receiver 1005, and a user interface (1001, 1002). Examples of signal receiver 1005 include single-carrier and multi-carrier receivers. Signal receiver 1005 and the user interface (1001, 1002) are coupled with the processing unit CPU 1003. One or more direct memory access (DMA) channels exist between multi-carrier signal terminal part 1005 and memory 1004. The user interface (1001, 1002) includes a display and a keyboard that enable a user to use the terminal 10000. In addition, the user interface (1001, 1002) includes a microphone and a speaker for receiving and producing audio signals. The user interface (1001, 1002) optionally employs voice recognition.

The processing unit CPU 1003 a microprocessor (not shown), memory 1004, and optionally software. The software is stored in the memory 1004. The microprocessor controls, on the basis of the software, the operation of the terminal 10000, such as receiving of a data stream, tolerance of the impulse burst noise in data reception, displaying output in the user interface and the reading of inputs received from the user interface. The hardware contains circuitry for detecting signal, circuitry for demodulation, circuitry for detecting impulse, circuitry for blanking those samples of the symbol where significant amount of impulse noise is present, circuitry for calculating estimates, and circuitry for performing the corrections of the corrupted data.

Still referring to FIG. 10, middleware or software implementation is optionally applied. Examples of terminal 10000 include a hand-held device such as a cellular mobile phone which includes the multi-carrier signal terminal part 1005 for receiving multicast transmission streams. Therefore, the terminal 10000 optionally interacts with service providers.

It is noted that although APs and STAs have been discussed at various junctures in connection with IEEE 802.11 so as to facilitate ease of discussion, the APs and STAs discussed herein are not limited to IEEE 802.11 APs and STAs. Non-limiting examples of APs discussed herein include access points (IEEE 802.11 and/or other than IEEE 802.11), access nodes, base stations, and other devices. Non-limiting examples of STAs discussed herein include stations (IEEE 802.11 and/or other than IEEE 802.11), mobile terminals, and other devices. APs and STAs discussed herein are, as non-limiting examples, of the networking modalities discussed above in connection with input output (I/O) interfaces 8057 and 8058.

Example embodiments of the invention include an apparatus, comprising:

means for receiving a message from an access node, wherein said message comprises an association identifier, and wherein said message does not comprise explicit target wake time indication; and

means for determining a target wake time correlating to the association identifier, wherein there is a predetermined correlation between the target wake time and the association identifier.

Example embodiments of the invention further include an apparatus, comprising:

means for accessing an association identifier; and

means for determining a target wake time correlating to the accessed association identifier, wherein there is a predetermined correlation between the target wake time and the association identifier.

### Ramifications and Scope

Although the description above contains many specifics, these are merely provided to illustrate the invention and should not be construed as limitations of the invention's scope. For instance, various examples are articulated herein via the discussion of certain aspects. Such aspects are, themselves, merely examples and should not be construed as limitations of the invention's scope. Thus it will be apparent to those skilled in the art that various modifications and variations are applicable to the system and processes of the present invention without departing from the spirit or scope of the invention.

In addition, the embodiments, features, methods, systems, and details of the invention that are described above in the application are combinable separately or in any combination to create or describe new embodiments of the invention.

What is claimed is:

1. A method, comprising:
receiving, at a device, a message from an access node, wherein said message comprises an association identifier, and wherein said message does not comprise explicit target wake time indication; and
determining, at the device, a target wake time correlating to the association identifier, wherein there is a predetermined correlation between the target wake time and the association identifier.

2. The method of claim 1, wherein said message further comprises a duration corresponding to the association identifier.

3. The method of claim 1, wherein the target wake time determination is further based on a duration corresponding to the association identifier.

4. The method of claim 1, further comprising determining, at the device, the association identifier to be a first association identifier in a sub-block, wherein the device, by such first association identifier determination, avoids calculation.

5. The method of claim 1, further comprising performing, at the device, a calculation with respect to the association identifier.

6. The method of claim 5, wherein the calculation is performed prior to receipt of the message.

7. A method, comprising:
accessing, at an access node device, an association identifier; and
determining, at the access node device, a target wake time correlating to the accessed association identifier, wherein there is a predetermined correlation between the target wake time and the association identifier.

8. The method of claim 7, further comprising accessing a duration corresponding to the association identifier.

9. The method of claim 7, wherein the target wake time determination is further based on an accessed duration corresponding to the association identifier.

10. The method of claim 7, further comprising determining, at the access node device, the association identifier to be a first association identifier in a sub-block, wherein the access node device, by such first association identifier determination, avoids calculation.

11. The method of claim 7, further comprising performing, at the access node device, a calculation with respect to the accessed association identifier.

12. The method of claim 11, wherein the calculation is performed prior to one or more of performing assignment with respect to the association identifier and performing notification with respect to the association identifier.

13. An apparatus, comprising:
at least one processor; and
at least one memory including computer program code, the at least one memory and the computer program code configured to, with the at least one processor, cause the apparatus at least to perform:
receive, at the apparatus, a message from an access node, wherein said message comprises an association identifier, and wherein said message does not comprise explicit target wake time indication; and
determine, at the apparatus, a target wake time correlating to the association identifier, wherein there is a predetermined correlation between the target wake time and the association identifier.

14. The apparatus of claim 13, wherein said message further comprises a duration corresponding to the association identifier.

15. The apparatus of claim 13, wherein the at least one memory and the computer program code are further configured to, with the at least one processor, cause the apparatus to perform, at the apparatus, a calculation with respect to the association identifier.

16. The apparatus of claim 15, wherein the calculation is performed prior to receipt of the message.

17. An apparatus, comprising:
at least one processor; and
at least one memory including computer program code, the at least one memory and the computer program code configured to, with the at least one processor, cause the apparatus at least to perform
access, at the apparatus, an association identifier; and
determine, at the apparatus, a target wake time correlating to the accessed association identifier, wherein there is a predetermined correlation between the target wake time and the association identifier.

18. The apparatus of claim 17, wherein the at least one memory and the computer program code are further configured to, with the at least one processor, cause the apparatus to access a duration corresponding to the association identifier.

19. The apparatus of claim 17, wherein the at least one memory and the computer program code are further configured to, with the at least one processor, cause the apparatus to perform, at the apparatus, a calculation with respect to the accessed association identifier.

20. The apparatus of claim 19, wherein the calculation is performed prior to one or more of performing assignment with respect to the association identifier and performing notification with respect to the association identifier.
